(19) United States
(12) Patent Application Publication
(10) Pub. No.: US 2018/0246851 A1
(43) Pub. Date: Aug. 30, 2018

(54) METHODS AND SYSTEMS FOR UNIFIED QUANTUM COMPUTING FRAMEWORKS

(71) Applicant: 1QB Information Technologies Inc., Vancouver (CA)

(72) Inventors: Arman ZARIBAFIYAN, Vancouver (CA); Ehsan ZAHEDINEJAD, Richmond (CA)

(21) Appl. No.: 15/900,643

(22) Filed: Feb. 20, 2018

Related U.S. Application Data
(63) Continuation of application No. PCT/CA2017/051610, filed on Dec. 29, 2017.
(60) Provisional application No. 62/440,645, filed on Dec. 30, 2016.

(51) Int. Cl. G06F 17/11; G06N 99/00; G06F 17/18; G06F 9/30; G06F 9/50

(52) U.S. Cl. CPC G06F 17/11; G06N 99/002; G06F 9/5027; G06F 9/30029; G06F 9/30018; G06F 17/18

(57) ABSTRACT

The present disclosure provides methods, systems, and non-transitory computer-readable media for hybrid computing integrating resources of classical computing and non-classical computing. A hybrid computing system may comprise an interface that receives a quadratic unconstrained binary optimization (QUBO) problem from a user, and a solver operatively coupled to the interface. The solver may solve the QUBO problem by a hybrid computer comprising a classical computer and a non-classical computer. The classical computer may comprise a digital processor and memory.

### CROSS-REFERENCE

This application is a continuation of International Application No. PCT/CA2017/051610, filed Dec. 29, 2017, which claims the benefit of U.S. Provisional Patent Application No. 62/440,645, filed Dec. 30, 2016, which is entirely incorporated herein by reference.

### BACKGROUND

Quantum computers make use of quantum-mechanical phenomena, such as superposition and entanglement, to perform operations on data. Quantum computers may be different from classical digital electronic computers based on transistors. For instance, where as digital computers require data to be encoded into binary digits (bits), each of which is always in one of two definite states (0 or 1), quantum computation uses quantum bits (qubits), which can be in superposition of states. Utilization of qubits allows processing more information and solving more difficult problems than digital computers.

### SUMMARY

The present disclosure describes a unified framework for taking an indication of a combinatorial optimization problem as an input. A first operation may transform the problem into a pseudo-boolean optimization problem. The framework may then formulate this pseudo-boolean problem into a Quadratic Unconstrained Binary Optimization (QUBO) problem. The formulation of the QUBO problem then can be changed upon the choice of the quantum algorithm to match the algorithm that used inside the solver. After determining the type of the algorithm, a solver may start to interact with a computing device (possibly a hybrid classical-quantum computing device). Postprocessing may include checking the satisfactory output on a computer, classical or non-classical. The procedure may end with an indication of a satisfactory solution.

In an aspect, disclosed herein is a hybrid computing system integrating resources of classical computing and non-classical computing, comprising: (a) an interface that receives a quadratic unconstrained binary optimization (QUBO) problem; and (b) a solver operatively coupled to the interface, wherein the solver solves the QUBO problem by a hybrid computer comprising a classical computer and a non-classical computer, which classical computer comprises a digital processor and a memory. Receiving the QUBO problem may comprise receiving a combinatorial optimization problem, formulating the combinatorial optimization problem into a pseudo-boolean optimization problem, and converting the pseudo-boolean optimization problem into the QUBO problem. Formulating the combinatorial optimization problem into the pseudo-boolean optimization problem may comprise representing a category variable by a binary variable. The interface may transform the QUBO problem into either a weighted maximum satisfiability model or an Ising spin model. The weighted maximum satisfiability model may be solved using the quantum random walk and backtracking algorithm. The Ising spin model may be solved using the Grover-based global optimization algorithm. The Ising spin model may be solved using an approximate quantum optimization algorithm. The solver may receive an input from the interface indicating the QUBO problem to be solved in a category of the weighted maximum satisfiability model or the Ising spin model. The input may indicate the QUBO problem to be solved by a quantum random walk and backtracking algorithm, or a Grover-based global optimization algorithm, or an approximate quantum optimization algorithm. The solver may configure the non-classical computer with quantum circuitry of the quantum random walk and backtracking algorithm, or the Grover-based global optimization algorithm, or the approximate quantum optimization algorithm. The solver may decompose the QUBO problem into a sequence of logical gates. Logical gates may be classical or quantum gates. The solver may operate the classical computer and the non-classical computer in parallel, or in series, or in a combination thereof. The interface may receive a computed solution from the solver and evaluates quality of the computed solution. The interface may indicate the computed solution as a satisfactory solution for the QUBO problem. The interface may receive the QUBO problem from a digital computer of the user. The digital computer of the user may be operatively coupled to the interface over a network. The interface may comprise a cloud interface. The interface may comprise an application programming interface. The non-classical computer may comprise a quantum computer.

In another aspect, disclosed herein is a method for integrating resources of classical computing and non-classical computing, the method comprising: (a) receiving a quadratic unconstrained binary optimization (QUBO) problem from a user; and (b) solving the QUBO problem by a hybrid computer comprising a classical computer and a non-classical computer, which classical computer comprises a digital processor and a memory. Receiving the QUBO problem may comprise receiving a combinatorial optimization problem, formulating the combinatorial optimization problem into a pseudo-boolean optimization problem, and converting the pseudo-boolean optimization problem into the QUBO problem. Formulating the combinatorial optimization problem into the pseudo-boolean optimization problem may comprise representing a category variable by a binary variable. The method may comprise transforming the QUBO problem into either a weighted maximum satisfiability model or an Ising spin model. The weighted maximum satisfiability model may be solved using the quantum random walk and backtracking algorithm. The Ising spin model may be solved using the Grover-based global optimization algorithm. The Ising spin model may be solved using an approximate quantum optimization algorithm. The method may comprise receiving an input indicating the QUBO problem to be solved in a category of the weighted maximum satisfiability model or the Ising spin model. The input may indicate the QUBO problem to be solved by a quantum random walk and backtracking algorithm, or a Grover-based global optimization algorithm, or an approximate quantum optimization algorithm. The method may comprise configuring the non-classical computer with quantum circuitry of the quantum random walk and backtracking algorithm, or the Grover-based global optimization algorithm, or the approximate quantum optimization algorithm. The method may comprise decomposing the QUBO problem into a sequence of logical gates. Logical gates may be classical or quantum gates. The method may comprise operating the classical computer and the non-classical computer in parallel, or in series, or in a combination thereof. The method may comprise receiving a computed solution and evaluating quality of the computed solution. The method may comprise indicating the computed solution as a satisfactory solution for the QUBO problem. The method may comprise receiving the QUBO problem from a digital computer of the user. The digital computer of the user may be operatively coupled to the hybrid computer over a network. The method may comprise using a cloud interface. The method may comprise using an application programming interface. The non-classical computer may comprise a quantum computer.

In another aspect, disclosed herein is a non-transitory computer-readable medium comprising machine-executable code that, upon execution, integrates resources of classical computing and non-classical computing, the medium comprising: (a) an interface that receives a quadratic unconstrained binary optimization (QUBO) problem; and (b) a solver operatively coupled to the interface, wherein the solver solves the QUBO problem by a hybrid computer comprising a classical computer and a non-classical computer, which classical computer comprises a digital processor and a memory. Receiving the QUBO problem may comprise receiving a combinatorial optimization problem, formulating the combinatorial optimization problem into a pseudo-boolean optimization problem, and converting the pseudo-boolean optimization problem into the QUBO problem. Formulating the combinatorial optimization problem into the pseudo-boolean optimization problem may comprise representing a category variable by a binary variable. The interface may transform the QUBO problem into either a weighted maximum satisfiability model or an Ising spin model. The weighted maximum satisfiability model may be solved using the quantum random walk and backtracking algorithm. The Ising spin model may be solved using the Grover-based global optimization algorithm. The Ising spin model may be solved using an approximate quantum optimization algorithm. The solver may receive an input from the interface indicating the QUBO problem to be solved in a category of the weighted maximum satisfiability model or the Ising spin model. The input may indicate the QUBO problem to be solved by a quantum random walk and backtracking algorithm, or a Grover-based global optimization algorithm, or an approximate quantum optimization algorithm. The solver may configure the non-classical computer with quantum circuitry of the quantum random walk and backtracking algorithm, or the Grover-based global optimization algorithm, or the approximate quantum optimization algorithm. The solver may decompose the QUBO problem into a sequence of logical gates. Logical gates may be classical or quantum gates. The solver may operate the classical computer and the non-classical computer in parallel, or in series, or in a combination thereof. The interface may receive a computed solution from the solver and evaluates quality of the computed solution. The interface may indicate the computed solution as a satisfactory solution for the QUBO problem. The interface may receive the QUBO problem from a digital computer of the user. The digital computer of the user may be operatively coupled to the interface over a network. The interface may comprise a cloud interface. The interface may comprise an application programming interface. The non-classical computer may comprise a quantum computer.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a flowchart of a unified framework for solving a general QUBO problem on a universal quantum computer.

FIG. 2A shows a problem formulation procedure to construct an input consistent with the type of the solver and quantum algorithm.

FIG. 2B shows a problem formulation procedure to construct an input consistent with the type of the solver and quantum algorithm.

FIG. 3 shows a system with a classical computing device interacting with a quantum computer.

FIG. 4 shows a computing architecture of the system.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### A Hybrid System

In various embodiments, the system, method, media and network described herein may include a hybrid computing system, or use of the same. A hybrid system may integrate resources of digital computing and quantum computing. In other words, the hybrid system may comprise a digital computer and a quantum computer coupled with the digital computer. The hybrid system may comprise an interface that receives a quadratic unconstrained binary optimization (QUBO) problem. The hybrid system may further comprise a solver to solve the QUBO problem.

Receiving the QUBO problem may comprise receiving a combinatorial optimization problem, formulating the combinatorial optimization problem into a pseudo-boolean optimization problem, and converting the pseudo-boolean optimization problem into the QUBO problem.

Formulating the combinatorial optimization problem into the pseudo-boolean optimization problem comprises representing category variables by binary variables. For example, representing categories A, B, C and D into binary numbers 00, 01, 10 and 11.

An interface may transform the QUBO problem into either a weighted maximum satisfiability model or an Ising spin model. The weighted maximum satisfiability model may be solved using the quantum random walk and backtracking algorithm. The Ising spin model may be solved using the Grover-based global optimization algorithm. In some cases, the Ising spin model may be solved using an approximate quantum optimization algorithm.

In some implementations, the solver receives an input from the interface indicating the QUBO problem to be solved in a category of the weighted maximum satisfiability model or the Ising spin model.

The input may be analyzed to indicate the QUBO problem to be solved by a quantum random walk and backtracking algorithm, or a Grover-based global optimization algorithm, or an approximate quantum optimization algorithm, or a combination thereof. In addition, the solver may configure the quantum computer with quantum circuitry of the quantum random walk and backtracking algorithm, or the Grover-based global optimization algorithm, or the approximate quantum optimization algorithm.

In some cases, a solver may decompose the QUBO problem by a sequence of logical gates. Logical gates may be classical or quantum. The solver may operate the digital computer and the quantum computer in parallel, or in series, or in a combination thereof.

The interface may further receive a computed solution from the solver and evaluates quality of the computed solution. The interface may indicate the computed solution as a satisfactory solution for the QUBO problem.

### Quadratic Unconstrained Binary Optimization

Quadratic Unconstrained Binary Optimization (QUBO) problems are ubiquitous in the field of combinatorial optimization and machine learning with many tasks in these fields can be formulated into a QUBO problem. A QUBO problem is to find an optimal configuration of an unconstrained pseudo-boolean objective function in terms of a series of binary values {0,1}. Solving a QUBO problem in a unified framework is of great value as often these general QUBO solvers provide solutions which are either superior or as good as the best specialized approaches both in terms of the quality and the efficiency. Another benefit is that the unified framework can minimize the cost of creating application-specific solvers.

Quantum computation has revolutionized the field of computational science by proposing algorithms that run faster than their classical counterparts. A classical computer may process computer-executable instructions using bits (e.g., 0's and 1's), whereas a quantum computer may execute instructions using qubits. Currently there exist two dominant paradigms of quantum computing namely; the adiabatic and gate model approaches, with each paradigm has its own strength and advantage. The technologies disclosed herein may solve a general QUBO problem using adiabatic quantum computing. In some cases, the technologies may focus on a unified framework that solves a general QUBO problem on a gate model quantum computer. Further, the technologies disclosed herein may solve any QUBO problems by a hardware-agnostic system, e.g., a classical system, or a non-classical system, or an adiabatic system, or a gate model quantum system. In addition, the hardware-agnostic system may be realized by a combination of a classical system and a non-classical system, or a combination of an adiabatic system and a gate model quantum, or a combination of a classical system and an adiabatic system, or a combination of a classical system and a gate model quantum system, or a combination of a classical system, an adiabatic system and a gate model quantum system.

A general QUBO problem is described below. A QUBO is an optimization task of a quadratic unconstrained pseudo-boolean function:

$$f ( {x}_{1} , … , {x}_{n} ) = {\sum }_{j = 1}^{n} ( {c}_{j} {x}_{j} ) + {\sum }_{1 \leq i < j \leq n} ( {d}_{ij} {x}_{i} {x}_{j} )$$

over the domain xᵢ∈{0,1}ⁿ where n is the number of variables. Currently there exist various quantum algorithms that can solve a general QUBO problem. The technologies disclosed herein create a unified framework that can exploit any quantum algorithm as a subroutine to solve a general QUBO problem. There can be various embodiments of quantum algorithms to be incorporated in the unified framework. Examples of these embodiments can be considered include, but not limited to, quantum global optimization enhanced by the Grover′ algorithms, digitizing the adiabatic quantum computing, and approximating the ground state of an Ising model.

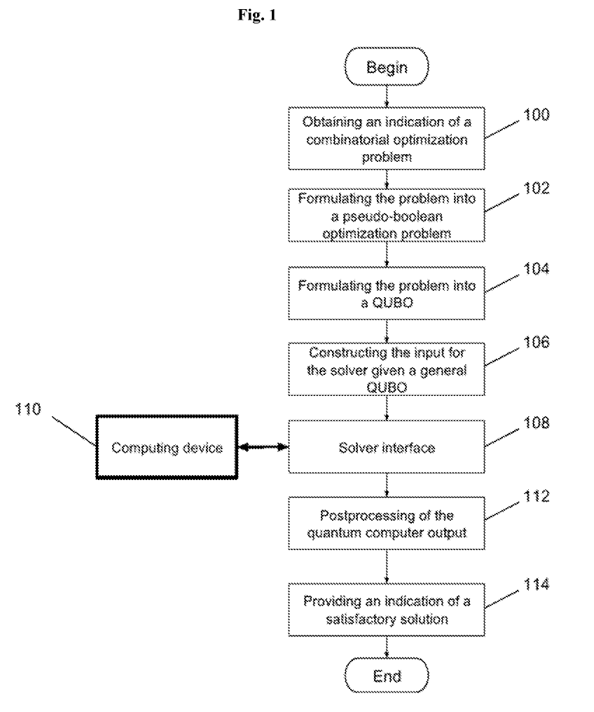

FIG. 1 illustrates a flowchart of an implementation of the unified framework for solving a general QUBO problem. Operation 100 may obtain an indication of a combinatorial optimization problem. Operation 102 may check whether the given combinatorial optimization problem can be formulated into a pseudo-boolean optimization problem or not. If such a transformation exists and it is computationally tractable, a transformation formula may be employed to convert a combinatorial optimization into a pseudo-boolean optimization problem. Operation 104 may convert a pseudo-boolean optimization problem into a QUBO problem. Process 106 may transform a QUBO into either a weighted maximum satisfiability or Ising spin model. An explicit transformation of how a QUBO can be transformed into a weighted maximum satisfiability or Ising spin model can be based on a system described in “The Ising model: teaching an old problem new tricks,”D-Wave Systems 2 (2010), which is entirely incorporated herein by reference. The Solver 108 may choose the type of the solver according to the choice of the quantum algorithm. The Solver 108 may then pass the appropriate input and also the structure of the quantum circuit corresponding to a computing device 110. The computing device 110 may be a hybrid computing device which can compute a logical function by decomposing it into a sequence of logical gates (either quantum or classical). Operation 112 may evaluate the output of a quantum computer, or a classical computer, or both, to check the quality of the solution. Operation 114 may obtain an indication of a satisfactory solution for the QUBO. Note that the flowchart in FIG. 1 may be altered based on practical needs. For instance, when a problem is already in the form of QUBO, operation 102 may be skipped.

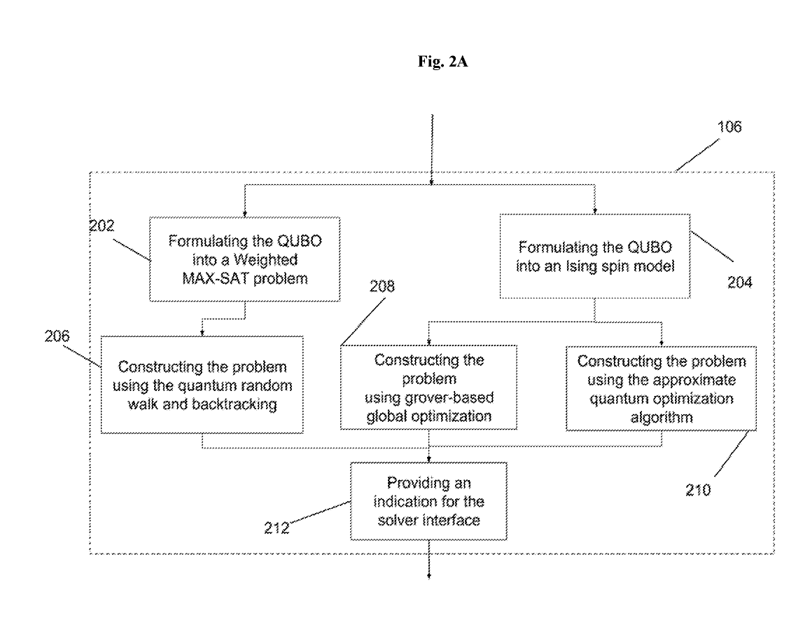

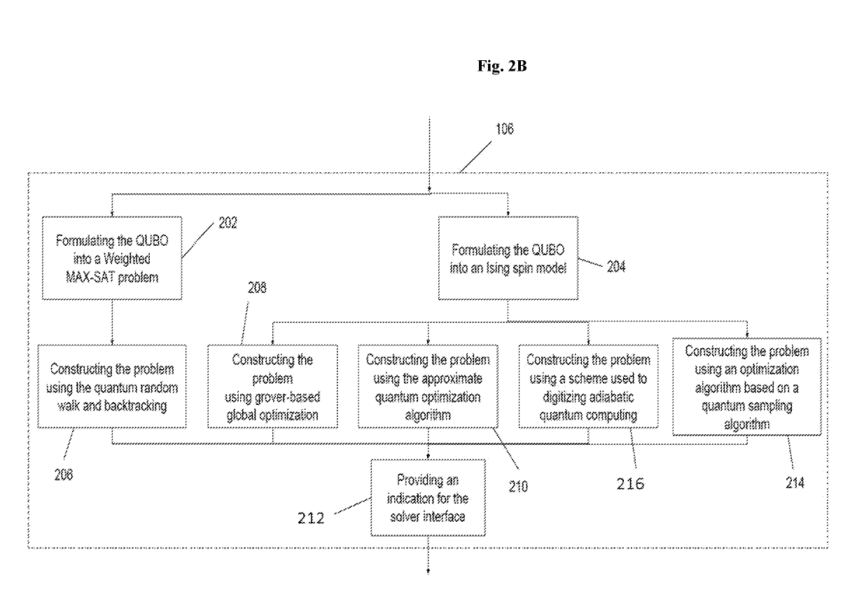

FIG. 2A illustrates a problem formulation procedure 106 of FIG. 1 to construct an input consistent with the type of the solver and quantum algorithm. Operation 202 may formulate a general QUBO into a weighted maximum satisfiability problem. Operation 204 may convert a QUBO problem into an Ising spin model. Operation 206 may employ the backtracking techniques enhanced by the quantum random walk. An example of such an algorithm is reported in “Quantum walk speedup of backtracking algorithms” by Montanaro, arXiv preprint arXiv: 1509.02374 (2015), which is entirely incorporated herein by reference. Operation 208 may construct a Grover-based global optimization framework for solving a general QUBO problem. The main component of this algorithm is a quantum oracle and a schedule which determines the number of rotation inside the Grover's algorithm itself. The operation 210 may take the Ising model as an input and construct the problem as a simulation of the adiabatic quantum Hamiltonian on a gate model quantum computer. In theory, given the time of the simulation and the initial state of the quantum system, the problem is turned into a Hamiltonian simulation problem for which there are efficient quantum algorithm for the case of k-body interacting quantum system. A system may utilize each term of the Hamiltonian with k-qubits. Each term of the Hamiltonian may be an operator acting on k-qubits of the system. Operation 212 may provide an indication for the solver interface. The interface may include the type of the quantum algorithms and the corresponding quantum circuits and the structure of the reformulated QUBO in terms of an oracle.

FIG. 2B illustrates a problem formulation procedure 106 of FIG. 1 to construct an input consistent with the type of the solver and quantum algorithm with similar operations 202, 204, 206, 208, 210, and 212, as in FIG. 2A. In this embodiment, two additional operations of constructing the problem, 214, 216, can be performed before sending the constructed problem the solver interface that enables unified quantum optimization. In this embodiment, problems that can be solved with quantum annealing can be solved on a gate model device using process 106. The operation 214 may take the Ising model as an input and construct the problem using schemes for digitized adiabatic quantum computing. The operation 214 may take the Ising model as an input and construct the problem using an optimization algorithm based on a quantum sampling algorithm. Operation 212 may provide an indication for the solver interface. The interface may include the type of the quantum algorithms and the corresponding quantum circuits and the structure of the reformulated QUBO in terms of an oracle.

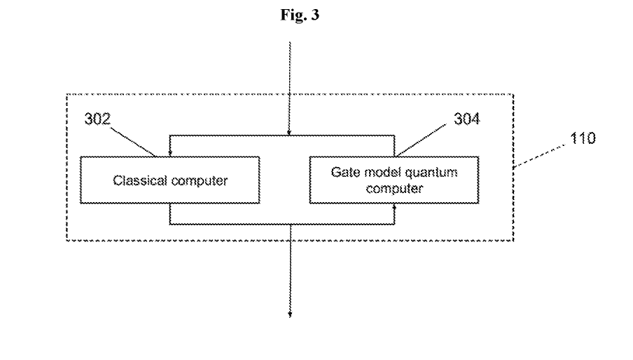

FIG. 3 illustrates a system 110 with a classical computing device 302 interacting with a gate model quantum computer 304. The classical and the quantum computers may run in parallel. The classical and the quantum computers may run in distributed manner. The classical and the quantum computers may run in a series mode.

Digital Processing Device

In some embodiments, the systems, media, networks and methods described herein include digital processing device, or use of the same. In some embodiments, the digital processing device includes one or more hardware central processing units (CPU) that carry out the device's functions. In some embodiments, the digital processing device further comprises an operating system configured to perform executable instructions. In some embodiments, the digital processing device is connected a computer network. In some embodiments, the digital processing device is connected to the Internet such that it accesses the World Wide Web. In some embodiments, the digital processing device is connected to a cloud computing infrastructure. In some embodiments, the digital processing device is connected to an intranet. In some embodiments, the digital processing device is connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases with computer network connectivity, may be suitable for use in the system described herein. Suitable tablet computers may include those with booklet, slate, and convertible configurations.

In some embodiments, the digital processing device includes an operating system configured to perform executable instructions. The operating system is, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® P53®, Sony® P54®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In some embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In some embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In some embodiments, the display is a thin film transistor liquid crystal display (TFT-LCD). In some embodiments, the display is an organic light emitting diode (OLED) display. In some embodiments, on OLED display is a passive-matrix OLED (PMOLED) or active-matrix OLED (AMOLED) display. In some embodiments, the display is a plasma display. In other embodiments, the display is a video projector. In some embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In some embodiments, the input device is a Kinect, Leap Motion, or the like. In some embodiments, the input device is a combination of devices such as those disclosed herein.

### Non-Transitory Computer Readable Storage Medium

In some embodiments, the systems, media, networks and methods described herein include one or more non-transitory computer readable storage media encoded with a program including instructions executable by the operating system of an optionally networked digital processing device. In some embodiments, a computer readable storage medium is a tangible component of a digital processing device. In some embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, networks and methods described herein include at least one computer program, or use of the same. A computer program includes a sequence of instructions, executable in the digital processing device's CPU, written to perform a specified task. Computer readable instructions may be implemented as program units, such as functions, objects, Application Programming Interfaces (APIs), data structures, and the like, that perform particular tasks or implement particular data types (e.g., abstract data types). In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In some embodiments, a computer program includes one or more software units. In some embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. A web application may utilize one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In some embodiments, suitable relational database systems include, by way of non-limiting examples, Microsoft® SQL Server, mySQL™ and Oracle®. A web application may be written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In some embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

A mobile application may be created, for example, using hardware, languages, and development environments. Mobile applications may be written in various programming languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums may be available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Standalone applications may be compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins may enable customizing the functionality of a software application. For example, plug-ins are commonly used in web browsers to play video, generate interactivity, scan for viruses, and display particular file types. Web browser plug-ins include, without limitation, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

Several plug-in frameworks are available that may enable development of plug-ins in various programming languages, including, by way of non-limiting examples, C++, Delphi, Java™, PHP, Python™, and VB .NET, or combinations thereof.

Web browsers (also called Internet browsers) are software applications, which may be configured for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) may be configured for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the systems, media, networks and methods described herein include software, server, and/or database modules, or use of the same. Software modules may be created using various machines, software, and programming languages. The software modules disclosed herein are implemented in a multitude of ways. In some embodiments, a software module comprises a file, a section of code, a programming object, a programming structure, or combinations thereof. In some embodiments, a software module comprises a plurality of files, a plurality of sections of code, a plurality of programming objects, a plurality of programming structures, or combinations thereof. In some embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In some embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting.

### Example 1—the Unified Computing Framework with Cloud Services

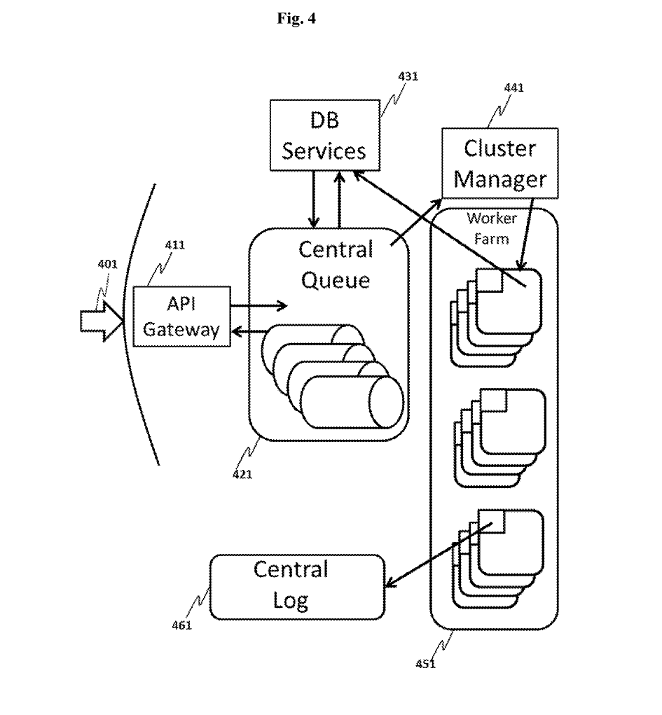

FIG. 4 shows a non-limiting example of a cloud computing architecture of the system with the unified framework. A request 401 comprising computational tasks may be transmitted to an API gateway 411. The request 401 is first handled by a queuing unit 421 which places the request in a queue. A database 431 communicates with the queuing unit 421 to record status and transactions of queues. The queuing unit 421 further transmits the recent state of the queue to the cluster manager 441. In this example, the cluster manager 441 is realized by an Apache Mesos server. The cluster manager 441 starts and controls the lifetime of certain types of computational components. The cluster manager 441 starts workers in worker farm 451 to perform integrated digital and quantum computations, such as translating to specific quantum computing instructions and controlling digital and quantum processors to execute computational tasks. A worker completing its assigned tasks is then destroyed by the cluster manager 441. A logging unit 461 communicates with workers to record all the events. Examples of features of such architecture and uses thereof are provided in U.S. Pat. No. 9,537,953 and U.S. patent application Ser. No. 15/486,960, each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for integrating resources of classical computing and non-classical computing, the method comprising:
(a) using an interface to receive a quadratic unconstrained binary optimization (QUBO) problem from a user; and
(b) solving the QUBO problem by a hybrid computer comprising a classical computer and a non-classical computer, wherein the classical computer comprises a digital processor and memory and the non-classical computer comprises a quantum processor comprising a sequence of quantum logic gates.

2. The method of claim 1, wherein using the interface to receive the QUBO problem comprises receiving a combinatorial optimization problem, formulating the combinatorial optimization problem into a pseudo-boolean optimization problem, and converting the pseudo-boolean optimization problem into the QUBO problem.

3. The method of claim 2, wherein formulating the combinatorial optimization problem into the pseudo-boolean optimization problem comprises representing a category variable by a binary variable.

4. The method of claim 2, further comprising transforming the QUBO problem into either a weighted maximum satisfiability model or an Ising spin model.

5. The method of claim 4, further comprising solving the weighted maximum satisfiability model using a quantum random walk and backtracking algorithm.

6. The method of claim 4, further comprising solving the Ising spin model using a Grover-based global optimization algorithm.

7. The method of claim 4, further comprising solving the Ising spin model using an approximate quantum optimization algorithm.

8. The method of claim 4, further comprising receiving an input indicating the QUBO problem to be solved in a category of the weighted maximum satisfiability model or the Ising spin model.

9. The method of claim 8, wherein the input indicates the QUBO problem to be solved at least in part by (i) a quantum random walk and backtracking algorithm, (ii) a Grover-based global optimization algorithm, or (iii) an approximate quantum optimization algorithm.

10. The method of claim 9, further comprising configuring the non-classical computer with (i) quantum circuitry of the quantum random walk and backtracking algorithm, (ii) the Grover-based global optimization algorithm, or (iii) the approximate quantum optimization algorithm.

11. The method of claim 9, further comprising decomposing the QUBO problem by a sequence of logical gates.

12. The method of claim 11, wherein the logical gates are classical or quantum gates.

13. The method of claim 9, further comprising operating the classical computer and the non-classical computer in parallel and/or in series.

14. The method of claim 9, further comprising receiving a computed solution and evaluating a quality of the computed solution.

15. The method of claim 14, further comprising indicating the computed solution as a satisfactory solution for the QUBO problem.

16. The method of claim 15, further comprising using the interface to transmit the computed solution to the user upon indicating that the computed solution is a satisfactory solution for the QUBO problem.

17. The method of claim 1, further comprising receiving the QUBO problem from a digital computer of the user.

18. The method of claim 16, wherein the digital computer of the user is operatively coupled to the hybrid computer over a network.

19. The method of claim 1, wherein the interface is a cloud interface.

20. The method of claim 1, wherein the interface is an application programming interface.

21. The method of claim 1, wherein the non-classical computer comprises a quantum computer.

22. The method of claim 1, further comprising using the interface to direct a solution to the QUBO problem to the user.

23. A hybrid computing system integrating resources of classical computing and non-classical computing, comprising:
an interface that receives a quadratic unconstrained binary optimization (QUBO) problem from a user; and
a solver operatively coupled to the interface, wherein the solver solves the QUBO problem by a hybrid computer comprising a classical computer and a non-classical computer, which classical computer comprises a digital processor and memory.

24.-44. (canceled)

45. A non-transitory computer-readable medium comprising machine-executable code that, upon execution, integrates resources of classical computing and non-classical computing, the medium comprising:
an interface that receives a quadratic unconstrained binary optimization (QUBO) problem; and
a solver operatively coupled to the interface, wherein the solver solves the QUBO problem by a hybrid computer comprising a classical computer and a non-classical computer, wherein the classical computer comprises a digital processor and memory and the non-classical computer comprises a quantum processor comprising of a sequence of quantum logic gates.

46.-66. (canceled)
